(19) United States
(12) Patent Application Publication
(10) Pub. No.: US 2010/0193572 A1
(43) Pub. Date: Aug. 5, 2010

(54) DAMPING DEVICE, WELDING SYSTEM FOR ROTARY FRICTION WELDING AND ROTARY FRICTION WELDING METHOD

(75) Inventors: Erwin Bayer, Dachau (DE); Steffen Weber, Dachau (DE)

Correspondence Address: HOWISON & ARNOTT, L.L.P, P.O. BOX 741715, DALLAS, TX, 75374-1715, US

(73) Assignee: MTU AERO ENGINES, GMBH, MUNICH (DE)

(21) Appl. No.: 12/671,487

(22) PCT Filed: Jul. 24, 2008
(86) PCT No.: PCT/DE08/01230

§ 371 Date: Jan. 29, 2010

(30) Foreign Application Priority Data
Aug. 4, 2007 (DE) 10 2007 036 960.5

(51) Int. Cl. B23K 20/12

(52) U.S. Cl. 228/112.1; 228/2.1; 228/57

(57) ABSTRACT

The invention relates to a damping device (20), which in order to reduce vibrations occurring during the rotary friction welding of a first to at least one second component (12a, 12b) can be disposed on at least one of said components (12a, 12b), wherein the damping device (20) comprises a casing element (22), which is filled at least partially with a viscoelastic fluid (24) invention further relates to a welding system (10) and to a method for the rotary friction welding of a first to at least one second component (12a, 12b), and to a component (12), particularly for an aircraft engine.

### CROSS-REFERENCE TO RELATED APPLICATIONS

This application is a U.S. National Phase application submitted under 35 U.S.C. §371 of Patent Cooperation Treaty application serial no. PCT/DE2008/001230, filed 24 Jul. 2008, and entitled DAMPING DEVICE, WELDING SYSTEM FOR ROTARY FRICTION WELDING, AND ROTARY FRICTION WELDING METHOD, which application claims priority to German patent application serial no. 10 2007 036 960.5, filed 4 Aug. 2007, and entitled DÄMPFUNGSEINRICHTUNG, SCHWEISSANGLAGE ZUM ROTATIONS SCHWEIS SEN UND ROTATIONSSCHWEISSVERFAHREN, the specifications of which are incorporated herein by reference in their entireties.

### TECHNICAL FIELD

The invention relates to a damping device, which can be arranged on at least one of the structural parts to lessen the vibrations occurring during rotary friction welding of a first structural part to at least a second structural part. The invention furthermore relates to a welding system and a method for rotary friction welding of a first structural part to at least one second structural part, especially for an aircraft engine.

### BACKGROUND

In rotary friction welding of a first to at least one second structural part, the heat needed to plasticize the material of the structural parts is generated by friction between the boundary surfaces of the two parts. Usually the first structural part is coupled to a rotary spindle of a welding layout, placed in a rotating motion, and moved onto the second structural part by applying an axial force, which in turn is coupled frictionally to a stationary spindle and thereby secured against torsion. The friction of the boundary surfaces occurring during the rubbing phase and the resulting heat warms the material of the two structural parts and the parts are forged together. However, the problem often arises that sonic waves of large amplitude are created in the structural parts, especially during the rubbing phase, which in the extreme instance can lead to cracks in the parts. To lessen these sonic waves, it is known, for example, from US 2004/0108358 A1, how to glue on a damping device in the region of a circular front surface of a first structural part and then remove this once again, after the rotary friction welding of the first part to a second part, through an opening between the two parts that is required for this purpose. The damping device in this case is made from a ring-shaped elastomer and it has incisions arranged in spiral fashion inside this ring. This has the effect that, when the damping device is being removed, it can unwind in threadlike fashion and therefore only a comparatively small opening is needed between the parts to remove the damping device.

One must consider it a drawback of the known damping device or the known method of rotary friction welding that this cannot be adapted, or only with relatively large expense, to various boundary conditions such as the particular geometrical configurations of the parts being welded together, resulting in lower weld seam qualities of the rotary friction welded parts.

### SUMMARY

Therefore, the problem of the present disclosure is to provide a damping device of the kind mentioned at the outset, which improves the welded seam qualities of rotary friction welded parts.

Furthermore, the problem of the present disclosure is to provide a welding system and a method for rotary friction welding of a first structural part to at least one second part of the kind mentioned at the outset, which improve the welded seam qualities of rotary friction welded parts.

Furthermore, the problem of the present disclosure is to provide a structural part of this kind that has improved welded seams.

The problems are addressed according to the disclosure by a damping device with the features as described and claimed herein, by a welding system for rotary friction welding with the features as described and claimed herein, by a method for rotary friction welding with the features as described and claimed herein, and by a structural part with the features of patent claim 24.

Advantageous configurations of the disclosure are indicated in the respective subclaims.

In order to provide rotary friction welded parts with improved welded seam qualities, a damping device is specified according to the disclosure, which comprises a casing element that is at least partly filled with a viscoelastic fluid. Thanks to such a damping element, the vibrations which occur during the rotary friction welding can be effectively lessened within at least one structural part, since the dimensioning of the casing element and the quantity and composition of the viscoelastic fluid can be chosen and optimally adapted according to the particular boundary conditions. Furthermore, by the quantity of the viscoelastic fluid one can influence the pressure exerted on the structural part. In contrast with the prior art, the disclosed damping device furthermore constitutes an easily adaptable centrifugal mass, so that the properties and requirements of the respective materials of the structural parts being welded together can also be given optimal consideration.

In one advantageous embodiment, the damping device can be arranged between the first structural part and a coordinated spindle of a welding layout and/or between the second structural part and a coordinated spindle of the welding layout and/or between the first and the second structural part. The arrangement between the structural part and the respective spindle allows the damping device to be easily removed and reused after the welding of the two structural parts to each other, thereby achieving a significant lowering of the process costs. The arrangement between the two structural parts, thanks to the flexible adaptability of the damping device, enables an especially effective reduction in the formation of sonic waves during the rotary friction welding. In contrast with the prior art, and thanks to the variability of the damping device, the arrangement can include a simple clamping between the structural parts or between structural part and spindle, which eliminates additional work steps, such as the subsequent removal of glue residue from the structural parts.

Furthermore, it has proven to be advantageous to configure the casing element as a cushion and/or ring. Such a configuration, thanks to the uniform bearing surface against the structural part, enables an especially reliable reduction in sonic waves. Moreover, especially when the damping device is arranged between the structural part and the spindle, a rotary symmetrical distribution of masses is achieved and the occurrence of a dynamic unbalanced mass is prevented.

In another advantageous embodiment, the casing element is made at least partly from an elastomer. Thanks to an at least partly elastic casing element, the size of the damping device can be optimally adapted to the particular geometrical circumstances. In the most simple embodiment, the adaptation can be brought about by filling the casing element with adjustable amounts of the viscoelastic fluid. Furthermore, the desired damping can be advantageously influenced by adapting the fill pressure.

An especially effective reduction of sonic waves is achieved in another advantageous embodiment in that the viscoelastic fluid contains dispersed metal particles. The size of the metal particles can be varied in dependence on the particular requirements, as well as the particular composition of the viscoelastic fluid, so that the metal particles are molecularly dispersed, colloidally dispersed, or coarsely dispersed. However, one can also provide for suspensions of macroscopic metal particles, which can accordingly absorb more vibrational energy. The metal particles can be added to the viscoelastic fluid before the filling of the casing element or be introduced afterwards in the casing element already filled with the fluid.

It has proven to be advantageous to prepare the metal particles by precipitation of metal salts dissolved in the fluid. By appropriate varying of the reaction partners and reaction conditions, this enables an especially precise adaptation of the type and size distribution of the resulting metal particles.

A fluid stable against unwanted precipitation of the metal particles is achieved in that the dispersed metal particles are present essentially in clusters with up to 100±15 atoms and thus are colloidally dissolved.

In a further embodiment, the stability of the metal particles against unwanted precipitation or agglomeration is advantageously enhanced in that the viscoelastic fluid contains at least one stabilizer, by means of which the dispersed metal particles are held in dispersion. The stabilizer can be chosen in dependence on the fluid and the metal particles. Furthermore, with the help of a stabilizer the most homogeneous possible distribution of the metal particles within the fluid can be guaranteed, despite the centrifugal forces which occur during the rotary friction welding.

In another advantageous embodiment, the viscoelastic fluid comprises a nonpolar and/or a polar and/or a protic solvent, especially water. This allows for an optimal adaptability of the rheological properties of the viscoelastic fluid. Furthermore, by suitable choice of the solvent, metal particles present in the fluid can be held reliably in dispersion.

The rheological properties of the viscoelastic fluid can be adapted especially easily to the particular requirements in that the fluid comprises a polymer. It has proven to be advantageous for the polymer to comprise a polypeptide, especially pectin and/or gelatin, and/or a polysaccharide, especially agarose and/or starch, and/or a polyacrylamide. Polypepties and polysaccharides, owing to their problem-free biodegradability, have the advantage of good environmental tolerability. Furthermore, they are available at cheap cost in large quantities and their handling has no problems. The use of polyacrylamides offers the benefit of an easy control of the desired degree of cross-linking by appropriate varying of the amounts of educts used.

A further aspect relates to a welding system for the rotary friction welding of a first and a second structural part, wherein an improved welded seam quality between the two structural parts can be achieved in that the at least one damping device comprises a casing element, which is at least partly filled with a viscoelastic fluid. Thanks to such a damping device, the vibrations occurring during the rotary friction welding can be effectively reduced within at least one structural part, since the dimensioning of the casing element as well as the quantity and composition of the viscoelastic fluid can be chosen and optimally adapted in dependence on the particular boundary conditions. It has proven to be advantageous for the at least one damping device to be configured according to the above-described sample embodiments. The benefits resulting from this are likewise described in the preceding descriptions of advantages and hold accordingly for the present welding system, while advantageous embodiments of the damping device—insofar as are applicable—should be regarded as advantageous embodiments of the welding system and vice versa.

In another advantageous embodiment, the at least one damping device can be arranged between the rotary spindle and the first structural part and/or between the stationary spindle and the second structural part and/or between the first and the second structural part. Thanks to such an arrangement of the at least one damping device, vibrations arising in particular in the rubbing-against phase can be reliably dampened. In the case of an arrangement between a structural part and its respective spindle, the vibrations can furthermore be carried away from the structural part to the spindle. Thus, the formation of cracks is reliably interdicted and a high quality welded seam is assured. The arrangement of the damping device between structural part and spindle is largely independent of the particular geometrical configuration of the structural part, which provides a problem-free ease of adaptation to the most diverse boundary conditions. In contrast with the prior art, moreover, it is not necessary to provide openings between the first and second structural part in the case of an arrangement between a structural part and the respective spindle, in order to remove the damping device once again after the friction welding is performed.

In another advantageous embodiment, the first and/or the second holding device comprises a chuck with at least one clamping jaw, and preferably three clamping jaws. This constitutes a simple-design, economical-cost, and reliable means of quickly and easily connecting the first and/or the second structural part to the respective spindle and releasing them from it.

In another advantageous embodiment, the first and/or the second structural part can be held on the rotary or the stationary spindle by at least one additional structural part. This enables a friction welding of multistaged structural parts, such as rotors for turbine construction.

It has proven to be advantageous to arrange the at least one damping device between the first and the at least one additional structural part and/or between the second and the at least one additional structural part. In this way, an especially effective reduction in the vibrations occurring during the rotary friction welding in the first or second structural part, as well as in the additional structural part, can be assured.

Another aspect concerns a method for rotary friction welding of a first to at least one second structural part in a welding layout, wherein according to the disclosure a damping device is used, which comprises a casing element that is at least partly filled with a viscoelastic fluid. The benefits resulting from this in terms of improved quality of the welded seam and lowering of process costs are already described in the preceding descriptions of advantages and also hold accordingly for the method disclosed herein.

It has proven to be especially advantageous to use a damping device according to the above-described sample embodiments. It can likewise be of advantage to carry out the method with the help of a welding system according to one of the likewise already described sample embodiments. The resulting benefits will be found in the respective descriptions of the advantages.

In another advantageous embodiment, the at least one damping device is arranged between the rotary spindle and the first structural part and/or between the stationary spindle and the second structural part and/or between the first and the second structural part. Thanks to such an arrangement of the at least one damping device, vibrations arising in particular in the rubbing-against phase can be reliably dampened and a high quality of welded seam assured.

In another advantageous embodiment, when arranging the at least one damping device at first the casing element is arranged between the rotary spindle and the first structural part and/or between the stationary spindle and the second structural part and then filled with an adjustable amount of viscoelastic fluid, so that the casing element bears at least in regions against the rotary spindle and the first structural part and/or against the stationary spindle and the second structural part. In this way, the first or second structural part can first be fastened to the respective spindle, then the casing element is arranged in a corresponding cavity between structural part and spindle and filled with the viscoelastic fluid in this position until the damping device bears against the structural part and against the spindle and vibrations which arise can be reliably decreased or carried away. By varying the fill volume of fluid, the dampening properties of the damping device can be deliberately influenced. Furthermore, it is not necessary in this case to glue the damping device to the structural part or to the spindle, so that on the one hand the damping device can be reused and on the other hand subsequent cleaning steps such as the removal of glue residue are eliminated. When the damping device is arranged between the first structural part and the rotary spindle, it is moreover possible to prevent the occurrence of a dynamic unbalanced mass during the rotary friction welding.

In another embodiment it has proven advantageous to hold the first and/or the second structural part on the rotary or the stationary spindle by at least one additional structural part. This also enables a rotary friction welding of multipiece structural parts. The damping device in this case can be variably arranged only between the additional structural part and the first and/or second structural part or also additionally between the additional structural part and the respective spindle or between the first and the second structural part in order to ensure an especially reliable reduction of vibrations.

Another aspect concerns a structural part, especially for an aircraft engine, wherein to ensure a heightened quality of welded seam the disclosure provides that the structural part is made by means of the previously described method. The structural part can be configured as a rotor for gas turbines, for example.

Further benefits, features and details of the invention will emerge from the following description of a sample embodiment and also from the drawings, in which the same or functionally identical elements are provided with identical references.

### BRIEF DESCRIPTION OF THE DRAWINGS

FIG. 1 shows a schematic side view of a welding system according to a sample embodiment, wherein two structural parts as well as a damping device are held on spindles of the welding system.

### DETAILED DESCRIPTION

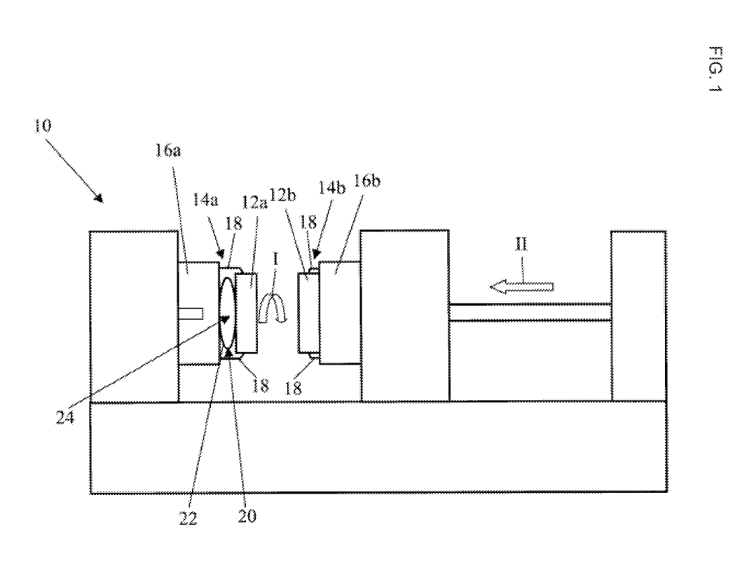

FIG. 1 shows a schematic side view of a welding system 10 for the rotary friction welding of a first structural part 12a and a second structural part 12b according to a sample embodiment. The first structural part 12a is held by means of a first holding device 14a against a rotary spindle 16a of the welding system 10, the second structural part 12b is held by a second holding device 14b torsion-proof against a stationary spindle 16b of the welding system 10. The holding devices 14a, 14b are designed as chucks and each comprise several clamping jaws 18, by which the structural parts 12a, 12b are coupled frictionally to the corresponding spindles 16a, 16b in the present sample embodiment.

For the rotary friction welding of the two structural parts 12a, 12b to each other, at first the first structural part 12a held on the rotary spindle 16a is moved in rotation in the direction of the arrow I, after which the stationary spindle 16b or the second structural part 12b is pressed against the first structural part 12a with an axial force in the direction of the arrow II. The person versed in the art is aware that the direction of rotation can also be chosen opposite the above, of course. Thanks to the friction the boundary surfaces of the two structural parts 12a, 12b and the resulting shear heating, the structural parts 12a, 12b are heated and hot-forged.

To reduce the vibrations occurring during the rotary friction welding within the structural parts 12a, 12b and thereby improve the welded seam produced between the structural parts 12a, 12b, a damping device 20 configured as a cushion in the present sample embodiment is arranged between the first structural part 12a and the rotary spindle 16a. The damping device 20 comprises a casing element 22 consisting of a thin, stretchable material—such as an elastomer—which is filled with an adjustable quantity of viscoelastic fluid 24 so that the casing element 22 bears reliably against both the first structural part 12a and the rotary spindle 16a. For this, after attaching the first structural part 12a to the rotary spindle 16a, the empty casing element 22 is first introduced into the space between the structural part 12a and spindle 16a and then filled with an appropriate amount of fluid 24. The particular desired dampening can be additionally adjusted via the quantity of fluid 24 and the fill pressure within the casing element 22 and be optimally adapted to the particular process conditions, such as dimension and material of the structural parts 12a, 12b. Metal particles (not depicted) consisting essentially of clusters of around 85-115 atoms are colloidally distributed in the viscoelastic fluid 24 and they can absorb at least some of the vibrational energy. The metal particles in the present sample embodiment are obtained by controlled precipitation of metal salts previously dissolved in the fluid 24, and the precipitation can basically occur before or after the filling of the casing element 22. The fluid 24 furthermore contains a stabilizer, by means of which the colloidal metal particles are protected from agglomerating. The stabilizer moreover prevents the metal particles from being forced outward during the rotation of the rotary spindle 16a and thus they remain homogeneously distributed within the casing element 22. Alternatively, it can also be arranged that macroscopic metal particles, which can absorb accordingly larger vibrational energies, are first mixed with the fluid 24 outside the casing element 22 and the fluid 24 is then filled into the casing element 22. Of course, here as well it is conceivable to add the metal particles only after the filling of the casing element 22. It can likewise be arranged to fill starting components not in themselves viscoelastic into the casing element 22 and form the viscoelastic properties of the fluid 24 only by mixing of the starting components inside the casing element 22. For example, in order to make the viscoelastic fluid 24, one can first fill gelatin powder into the casing element 22 and then mix it with an appropriate amount of water to create the gel forming the viscoelastic fluid 24. By varying the composition of the viscoelastic fluid 24, one can deliberately influence the dampening properties of the damping device 20.

Thanks to the rotationally symmetrical configuration of the damping device 20, a rotationally symmetrical distribution of mass of the rotating elements of the welding system 10 is achieved at the same time and thus the occurrence of an unbalanced mass, especially a dynamic one, is prevented during the rotary friction welding. Furthermore, the damping device 20 constitutes an additional adjustable centrifugal mass. In contrast with the sample embodiment depicted, one can also arrange the damping device 20 between the second structural part 12b and the stationary spindle 16b. Likewise, several damping devices 20 can also be used and arranged between the respective spindles 16a, 16b and structural parts 12a, 12b and/or between the first and the second structural part 12a, 12b. When working with multipiece structural parts 12, such as in the case of multistage rotors for gas turbines, one can likewise have the first and/or second structural part 12a, 12b held against the rotary and stationary spindle 16a, 16b by at least one additional structural part 12 (not depicted) and arrange the damping device 20 additionally or alternatively between the first or second structural part 12a, 12b and the additional structural part 12.

1-24. (canceled)

25. A damping device to lessen the vibrations occurring during rotary friction welding of a first structural part to at least a second structural part, the damping device comprising:
a fillable casing element formed of a thin, stretchable material; and
a viscoelastic fluid, the viscoelastic fluid at least partially filling the casing element.

26. A damping device in accordance with claim 25, wherein:
the casing element is adapted to be positioned in one of
a) a space between a structural part and a rotary spindle of a welding layout,
b) a space between a structural part and a stationary spindle of a welding layout or
c) a space between a first and a second structural part; and
the casing element is further adapted to bear reliably against the respective structural parts and/or spindle on either side of the space after filling with an adjustable quantity of viscoelastic fluid.

27. A damping device in accordance with claim 25, wherein the casing element is configured as a cushion and/or a ring.

28. A damping device in accordance with claim 25, wherein the casing element is made at least partly from an elastomer.

29. A damping device in accordance with claim 25, wherein the viscoelastic fluid contains dispersed metal particles.

30. A damping device in accordance with claim 29, wherein the metal particles are prepared by precipitation of metal salts dissolved in the viscoelastic fluid.

31. A damping device in accordance with claim 29, wherein the dispersed metal particles are present essentially in clusters with up to 100±15 atoms.

32. A damping device in accordance with claim 29, wherein the viscoelastic fluid contains at least one stabilizer, by means of which the dispersed metal particles are held in dispersion.

33. A damping device in accordance with claim 25, wherein the viscoelastic fluid comprises at least one material selected from the group consisting of nonpolar solvents, polar solvents, protic solvents and water.

34. A damping device in accordance with claim 25, wherein the viscoelastic fluid comprises a polymer

35. A damping device in accordance with claim 34, wherein the polymer comprises at least one material selected from the group consisting of polypeptides, polysaccharides and polyacrylamides.

36. A welding system for the rotary friction welding of a first structural part to at least one second structural part, the system comprising:
a rotary spindle having an axis of rotation;
a first holding device by means of which a first structural part can be held on the rotary spindle to impart a rotating motion to the first structural part;
a stationary spindle;
a second holding device by means of which a second structural part can be held on the stationary spindle;
at least one damping device including
a fillable casing element formed of a thin, stretchable material and
a viscoelastic fluid at least partially filling the casing element;
wherein the rotary spindle and the stationary spindle are movable relative to each other along the axis of rotation in order to press the first and second structural parts together with an axial pressure; and
wherein the at least one damping device reduces vibrations within the first and/or the second structural part occurring during the rotary friction welding.

37. A welding system in accordance with claim 36, wherein the damping device is adapted to be positioned in one of:
a) a space between a structural part and a rotary spindle;
b) a space between a structural part and a stationary spindle; and
c) a space between a first and a second structural part.

38. A welding system in accordance with claim 36, wherein at least one of the first holding device and the second holding device includes a chuck with at least one clamping jaw.

39. A welding system in accordance with claim 36, wherein at least one of the first structural part and the second structural part is held on its respective spindle by at least one additional structural part.

40. A welding system in accordance with claim 36, wherein the at least one damping device is positioned between one of:
a) the first structural part and the at least one additional structural part; and
b) the second structural part and the at least one additional structural part.

41. A method for rotary friction welding of a first structural part to at least one second structural part, the method comprising the following steps:
providing a welding system wherein a first structural part is held by means of a first holding device on a rotary spindle having an axis of rotation and the second structural part is held by means of a second holding device on a stationary spindle;
positioning at least one damping device including a casing element that is at least partly filled with a viscoelastic fluid against one of the first structural part, the second structural part, the rotary spindle and the stationary spindle;
rotating the rotary spindle and first structural part while moving the rotary spindle and first structural part along the axis of rotation relative to the stationary spindle and the second structural in order to press the first and second structural parts together with an axial pressure until the first and second structural parts are welded together.

42. A welding system in accordance with claim 41, wherein the at least one damping device is positioned in one of:
a) a space between the first structural part and the rotary spindle; and
b) a space between the second structural part and the stationary spindle.

43. A welding system in accordance with claim 42, wherein while positioning the at least one damping device:
the casing element is first arranged between the rotary spindle and the first structural part or between the stationary spindle and the second structural part; and
the casing element is then filled with an adjustable amount of viscoelastic fluid, so that the casing element bears at least in regions against the respective spindle and structural part.

44. A structural part, especially for an aircraft engine, made using a method of rotary friction welding in accordance with claim 41.
